(19) United States
(12) Patent Application Publication
(10) Pub. No.: US 2016/0357286 A1
(43) Pub. Date: Dec. 8, 2016

(54) DISPLAY DEVICE

(71) Applicant: InnoLux Corporation, Miao-Li County (TW)

(72) Inventors: Chu-Hung TSAI, Miao-Li County (TW); Hung-Kun CHEN, Miao-Li County (TW); Li-Wei SUNG, Miao-Li County (TW); Tung-Kai LIU, Miao-Li County (TW); Chia-Hao TSAI, Miao-Li County (TW); Chih-Hao CHANG, Miao-Li County (TW); Bo-Feng CHEN, Miao-Li County (TW)

(21) Appl. No.: 15/161,035

(22) Filed: May 20, 2016

Related U.S. Application Data
(60) Provisional application No. 62/202,570, filed on Aug. 7, 2015.
(60) Provisional application No. 62/193,787, filed on Jul. 17, 2015.
(60) Provisional application No. 62/174,728, filed on Jun. 12, 2015.
(60) Provisional application No. 62/171,592, filed on Jun. 5, 2015.

(30) Foreign Application Priority Data
Nov. 20, 2015 (TW) 104138431

(51) Int. Cl. G06F 3/044

(52) U.S. Cl. CPC G06F 3/044; G06F 2203/04103

(57) ABSTRACT

A display device is provided. The display device includes a first substrate, wherein the first substrate includes: a plurality of scan lines disposed on the first substrate; a plurality of data lines disposed on the first substrate, wherein the plurality of the scan lines and the plurality of the data lines define a plurality of sub-pixels; and a sensing electrode disposed on the first substrate and having an opening; a second substrate disposed opposite the first substrate; and a display medium disposed between the first substrate and the second substrate, wherein the sensing electrode is disposed corresponding to at least two of the plurality of sub-pixels, and the opening is disposed corresponding to one of the plurality of scan lines or one of the plurality of data lines.

### CROSS REFERENCE TO RELATED APPLICATIONS

This application claims priority to Taiwan Patent Application No. 104138431, filed on Nov. 20, 2015. This application also claims the benefit of the following provisional U.S. provisional applications: application No. 62/171,592 filed on Jun. 5, 2015, application No. 62/174,728 filed on Jun. 12, 2015, application No. 62/193,787 filed on Jul. 17, 2015, and patent Application No. 62/202,570 filed on Aug. 7, 2015, the entireties of which are incorporated by reference herein.

### BACKGROUND OF THE INVENTION

### Field of the Invention

The disclosure relates to a display device, and in particular to a touch display device having a sensing electrode.

### Description of the Related Art

As technology progresses, several information devices are being developed, such as mobile phones, tablet PCs, ultra-thin laptops, and satellite navigation. In addition to using a keyboard or mouse for keying in and control, a popular way to control information devices is by touch technology. The touch display device has a friendly and intuitive human-machine interface so that users of all ages may select or control their information devices by using fingers or a stylus outright.

One of these touch display devices is the in-cell touch display device, which has a sensing electrode disposed in the display panel (such as a liquid-crystal display panel or an organic light-emitting diode panel). However, the existing devices of in-cell touch display have not been satisfactory in every respect.

Therefore, an in-cell touch display device with improved qualities of the display and the touch-control is necessary in future.

### BRIEF SUMMARY OF THE INVENTION

The present disclosure provides a display device, including: a first substrate, wherein the first substrate includes: a plurality of scan lines disposed on the first substrate; a plurality of data lines disposed on the first substrate, wherein the plurality of the scan lines and the plurality of the data lines define a plurality of sub-pixels; and a sensing electrode disposed on the first substrate and having an opening; a second substrate disposed opposite the first substrate; and a display medium disposed between the first substrate and the second substrate, wherein the sensing electrode is disposed corresponding to at least two of the sub-pixels, and the opening is disposed corresponding to one of the scan lines or one of the data lines.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1A is a top view of a display device in accordance with some embodiments of the present disclosure;

FIG. 1B is a partially enlarged figure of the display device in FIG. 1A;

FIG. 2A is a cross-sectional view along line 2A-2A in FIG. 1B in accordance with some embodiments of the present disclosure;

FIG. 2B is a cross-sectional view of a display device in accordance with another embodiment of the present disclosure;

FIG. 3A is a top view of a display device in accordance with another embodiment of the present disclosure;

FIG. 3B is a top view of a display device in accordance with another embodiment of the present disclosure;

FIG. 3C is a top view of a display device in accordance with another embodiment of the present disclosure;

FIG. 3D is a top view of a display device in accordance with another embodiment of the present disclosure;

FIG. 3E is a top view of a display device in accordance with another embodiment of the present disclosure;

FIG. 4 is a top view of a display device in accordance with another embodiment of the present disclosure;

FIG. 5A is a top view and a partially enlarged figure of the display device in FIG. 4;

FIG. 5B is a bottom view and a partially enlarged figure of the display device in FIG. 4;

FIG. 5C is a cross-sectional view along line 5C-5C in FIGS. 5A-5B in accordance with some embodiments of the present disclosure;

FIG. 5D is a cross-sectional view along line 5D-5D in FIGS. 5A-5B in accordance with some embodiments of the present disclosure;

FIG. 6A is a top view of a display device in accordance with another embodiment of the present disclosure;

FIG. 6B is a bottom view of a display device in accordance with another embodiment of the present disclosure;

FIG. 6C is a cross-sectional view along line 6C-6C in FIGS. 6A-6B in accordance with some embodiments of the present disclosure;

FIG. 6D is a cross-sectional view along line 6D-6D in FIGS. 6A-6B in accordance with some embodiments of the present disclosure;

FIG. 7A is a top view of a display device in accordance with another embodiment of the present disclosure;

FIG. 7B is a partially enlarged figure of the display device in FIG. 7A;

FIG. 8A is a top view of a display device in accordance with another embodiment of the present disclosure;

FIG. 8B is a partially enlarged figure of the display device in FIG. 8A;

FIG. 8C is a partially enlarged figure of the display device in FIG. 8A;

FIG. 9A is a top view of a display device in accordance with another embodiment of the present disclosure; and

FIG. 9B is a top view of a display device in accordance with another embodiment of the present disclosure.

### DETAILED DESCRIPTION OF THE INVENTION

The display device of the present disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. In addition, in this specification, expressions such as “first material layer disposed on/over a second material layer”, may indicate the direct contact of the first material layer and the second material layer, or it may indicate a non-contact state with one or more intermediate layers between the first material layer and the second material layer. In the above situation, the first material layer may not be in direct contact with the second material layer.

It should be noted that the elements or devices in the drawings of the present disclosure may be present in any form or configuration known to those skilled in the art. In addition, the expression “a layer overlying another layer”, “a layer is disposed above another layer”, “a layer is disposed on another layer” and “a layer is disposed over another layer” may indicate that the layer is in direct contact with the other layer, or that the layer is not in direct contact with the other layer, there being one or more intermediate layers disposed between the layer and the other layer.

In addition, in this specification, relative expressions are used. For example, “lower”, “bottom”, “higher” or “top” are used to describe the position of one element relative to another. It should be appreciated that if a device is flipped upside down, an element that is “lower” will become an element that is “higher”.

The terms “about” and “substantially” typically mean +/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. When there is no specific description, the stated value includes the meaning of “about” or “substantially”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another region, layer or section. Thus, a first element, component, region, layer, portion or section discussed below could be termed a second element, component, region, layer, portion or section without departing from the teachings of the present disclosure.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

This description of the exemplary embodiments is intended to be read in connection with the accompanying drawings, which are to be considered part of the entire written description. The drawings are not drawn to scale. In addition, structures and devices are shown schematically in order to simplify the drawing.

In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The term “substrate” refers to the substrate itself, or to a composite object that includes various elements, various electrical wires and various films formed over a substrate. However, the substrate is represented by a flat surface in order to simplify the drawing. The term “substrate surface” is meant to include the uppermost exposed layers on the substrate, such as a glass surface, an organic polymer surface, and insulating layer and/or metallurgy lines. The substrate may include glass, organic polymer, inorganic polymer, silicon, metal, or any other suitable materials.

In display devices, the electric field distribution at the inner portion of the sensing electrode are different from the electric field distribution at the edge of the sensing electrode. Therefore, the capacitance between the inner portion of the sensing electrode and the other elements is different from the capacitance between the edge of the sensing electrode and the other elements, which in turn results in light leakage of the display devices and decreases the display quality. In addition, if the sensing electrode overlaps with the gate line, data line or touch signal line, parasitic capacitance may result. Therefore, the shape and size of the sensing electrode would affect the parasitic capacitance at the inner portion and edge of the sensing electrode, and would make the parasitic capacitance at the inner portion of the sensing electrode differ from the parasitic capacitance at the edge of the sensing electrode. This would result in signal cross-talk between the electrodes, which in turn affects the image and touch-control performance.

The embodiments of the present disclosure make the electric field distribution at the inner portion of the sensing electrode similar to the electric field distribution at the edge of the sensing electrode. Therefore, the capacitance between the inner portion of the sensing electrode and the other elements may be similar to the capacitance between the edge of the sensing electrode and the other elements, which in turn reduces light leakage in the display devices and improves the display quality. In addition, the parasitic capacitance between the sensing electrode and the scan line, data line or touch signal line may be reduced, which in turn improves the image and touch-control performance.

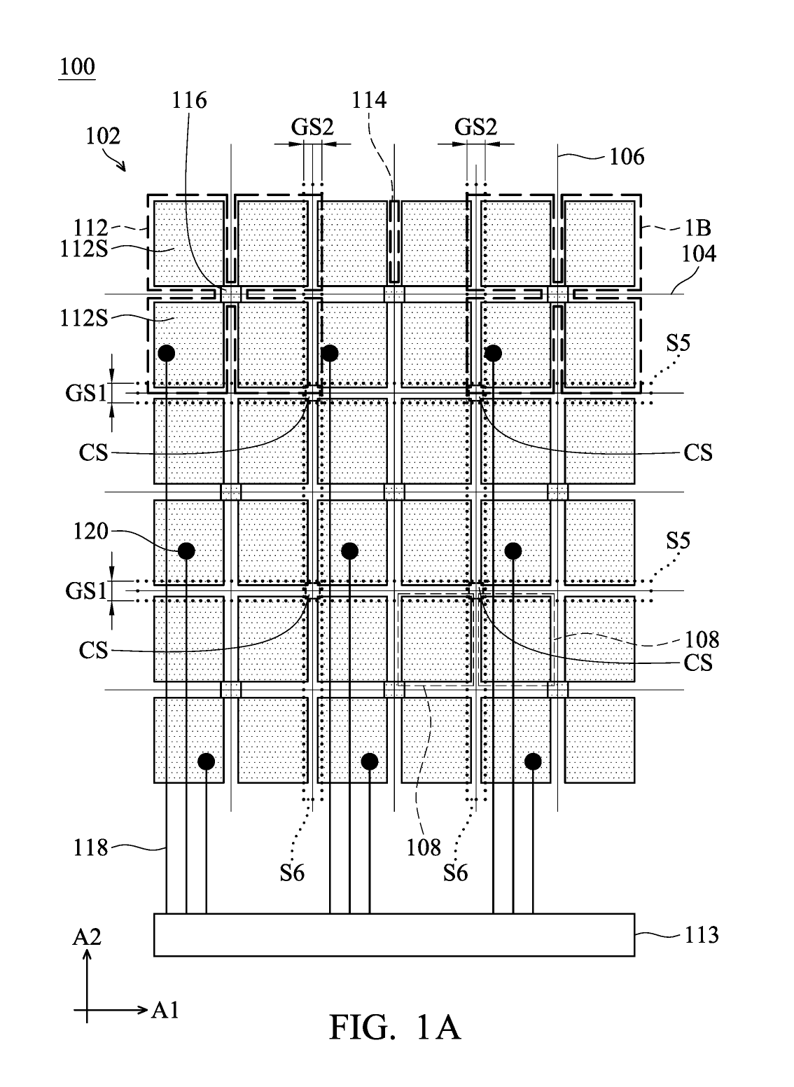

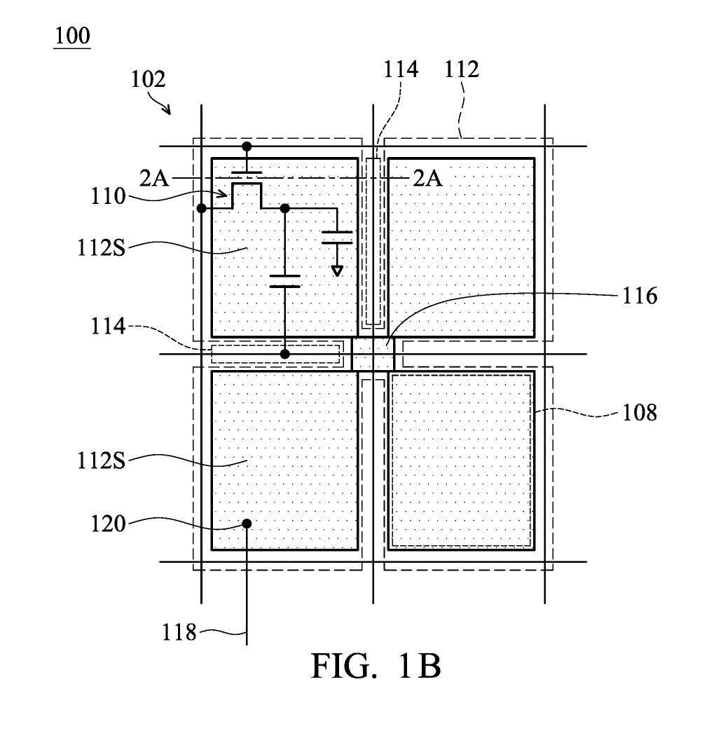

FIG. 1A is a top view of a first substrate 102 of a display device 100 in accordance with some embodiments of the present disclosure. FIG. 1B is a partially enlarged figure of the first substrate 102 of the display device 100 in region 1B in FIG. 1A. As shown in FIGS. 1A-1B, the substrate 102 may include a plurality of scan lines (gate lines) 104, which extends along a first direction A1 and is parallel to each other. The substrate 102 may further include a plurality of data lines (source lines) 106, which intersects the scan line 104 and extends along a second direction A2 and is parallel to each other. The first direction A1 is substantially perpendicular or orthogonal to the second direction A2. In other words, the first direction A1 may be the X-axis of the coordinate system, and the second direction A2 may be the Y-axis of the coordinate system. However, in other embodiments, the first direction A1 may be not substantially perpendicular or orthogonal to the second direction A2. The included angle between the first direction A1 and second direction A2 is not 90 degrees. In addition, the scan lines 104 and data lines 106 are all disposed on the first substrate 102.

In addition, the plurality of scan lines 104 and the plurality of data lines 106 define a plurality of sub-pixels 108. The first substrate 102 may include a plurality of sub-pixels 108. In addition, the substrate 102 may further include a plurality of thin film transistors 110 corresponding to sub-pixels 108. Two terminals of the thin film transistor 110 are electrically connected to the scan line 104 and the data line 106 respectively, as shown in FIG. 1B. Numbers of sub-pixels 108 may form a pixel.

The data line 106 may provide the source signal to the sub-pixels 108 through the thin film transistors 110. The scan line (gate line) 104 may provide the scanning pulse signal to the sub-pixels 108 through the thin film transistors 110 and control the sub-pixels 108 in coordination with the aforementioned source signal.

Still referring to FIGS. 1A-1B, the substrate 102 may further include a plurality of sensing electrodes 112 disposed on the substrate 102. The plurality of sensing electrodes 112 covers the plurality of sub-pixels 108. In this embodiment, the sensing electrode 112 covers four sub-pixels 108. There is a first spacing S5 between the sensing electrodes 112 and extending along the first direction A1. There is a second spacing S6 between the sensing electrodes 112 and extending along the second direction A2. There is a first distance GS1 between the sensing electrodes 112 along the second direction A2. The first distance GS1 is the width of the short side of the first spacing G1 along the second direction A2. There is a second distance GS2 between the sensing electrodes 112 along the first direction A1. The second distance GS2 is the width of the short side of the second spacing G2 along the first direction A1. The first spacing S5 is disposed corresponding to a portion of the scan line 104, and the second spacing S6 is disposed corresponding to a portion of the data line 106. The portions where the first spacing S5 overlaps with the second spacing S6 are intersection portions CS. The intersection portions CS correspond to the portions where the scan line 104 overlaps with the data line 106. In this embodiment, the width of the first distance GS1 is the same as that of the second distance GS2. However, in other embodiments, the width of the first distance GS1 may be different from that of the second distance GS2.

At least one of the sensing electrodes 112 has an opening 114. The opening 114 is disposed corresponding to a portion of the scan lines 104 or a portion of the data lines 106. The opening 114 is disposed in the region corresponding to the sensing electrodes 112. The portion of the scan lines 104 or the portion of the data lines 106 which the opening 114 corresponds to is the portion of the scan lines 104 which the first spacing 55 does not correspond to or the portion of the data lines 106 which the second spacing S6 does not correspond to. In this embodiment, the opening 114 is the branch portion of the first spacing 55 which extends along the second direction A2 and is not the CS portion. Alternatively, the opening 114 is the branch portion of the second spacing S6 which extends along the first direction A1 and is not the CS portion. In other embodiments, the opening 114 is disposed in the region corresponding to the sensing electrodes 112. And the opening 114 does not connect to the first spacing S5 and second spacing S6.

The capacitance resulting from the overlap between the sensing electrodes 112 and the scan lines 104 or data lines 106 is different from the capacitance between the edge of the sensing electrode and the scan lines 104 or data lines 106. In the embodiments of the present disclosure, by disposing the opening 114 corresponding to the scan lines 104 or data lines 106, most portion in the sensing electrodes 112 may bypass the scan lines 104 or data lines 106, such that the electric field distribution at most of the inner portion of the sensing electrode may be similar to the electric field distribution at the edge of the sensing electrode. Therefore, the capacitance between the inner portion of the sensing electrode and the other elements may be similar to the capacitance between the edge of the sensing electrode and the other elements, which in turn reduces light leakage in the display device 100 and improves the display quality. On the other hand, since the overlap between the sensing electrodes 112 and the scan lines 104 or data lines 106 is decreased, the parasitic capacitance between the sensing electrode 112 and the scan line 104 or data line 106 may be reduced, which in turn improves the image and touch-control performance.

In particular, referring to FIGS. 1A-1B, at least one sensing electrode 112 may include a plurality of sub-sensing electrodes 112S and a connection portion 116. The sub-sensing electrodes 112S are spaced apart from each other by the opening 114. The sub-sensing electrodes 112S are electrically connected to each other through the connection portion 116.

In addition, in some embodiments, the connection portion 116 is disposed at the center portion of the four sub-sensing electrodes 112S which are adjacent to each other. For example, in this embodiment, the sensing electrode 112 is formed by four sub-sensing electrodes 112S which are adjacent to each other, and the connection portion 116 is disposed at the center portion of the four sub-sensing electrodes 112S which are adjacent to each other. In addition, in this embodiment, each sub-sensing electrode 112S is disposed corresponding to one sub-pixel 108.

Except for the connection portion 116, the region of the sensing electrodes 112 corresponding to the scan line 104 and/or data lines 106 has the opening 114. Thereby, the electric field distribution between the most region of the inner portion of the sensing electrode 112 and the scan line 104 or data lines 106 may be similar to the electric field distribution between the edge of the sensing electrode 112 and the scan line 104 or data lines 106. Therefore, the capacitance between the inner portion of the sensing electrode 112 and the other elements may be similar to the capacitance between the edge of the sensing electrode 112 and the other elements, which in turn reduces light leakage in the display device 100 and improves the display quality. On the other hand, since the overlap between the sensing electrode 112 and the scan lines 104 or data lines 106 is decreased, the parasitic capacitance between the sensing electrode 112 and the scan line 104 or data line 106 may be reduced, which in turn improves the image and touch-control performance. In some embodiments of the present disclosure, the area of the sensing electrode 112 which has the opening 114 is about 50%-90% times the area of the sensing electrode 112 which does not have the opening 114. In other words, the ratio of the area of the sensing electrode 112 to the area of the opening 114 ranges from about 1 to 9.

In addition, the first substrate 102 further includes a touch signal line 118. One terminal of the touch signal line 118 is electrically connected to the sensing electrode 112 through a via 120, and another terminal of the touch signal line 118 is electrically connected to an IC bonding region 113. It should be noted that, the position of the touch signal line 118 is not limited to that shown in FIGS. 1A-1B. In some other embodiments of the present disclosure, the touch signal line 118 may be disposed on the data lines 106.

It should be noted that the exemplary embodiment set forth in FIGS. 1A-1B is merely for the purpose of illustration. In addition to the embodiment set forth in FIGS. 1A-1B, one sensing electrodes may include another amount of sub-sensing electrodes. Therefore, the inventive concept and scope are not limited to the exemplary embodiment shown in FIGS. 1A-1B. In addition, the connection portion 116 and sub-sensing electrodes 112S in FIGS. 1A-1B may be formed in the same manufacturing step or in different manufacturing steps according to requirements. The materials of the connection portion 116 and sub-sensing electrodes 112S may be the same or different.

In addition, it should be noted that in order to clearly describe the present disclosure, FIGS. 1A-1B do not show the subsequent pixel electrode.

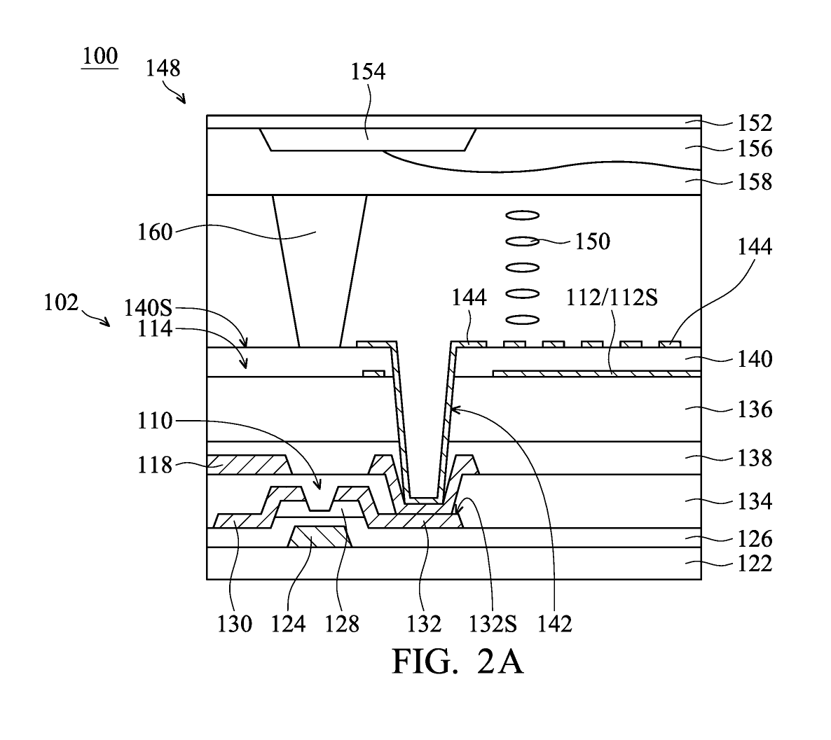

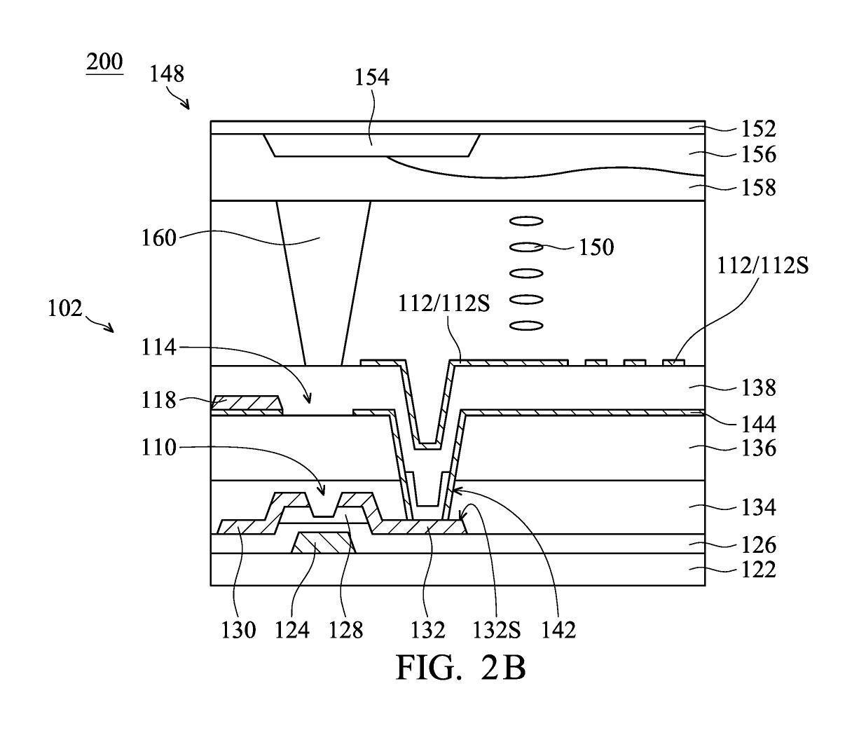

FIG. 2A is a cross-sectional view of the display device 100 along line 2A-2A in FIG. 1B in accordance with some embodiments of the present disclosure. As shown in FIG. 2A, the first substrate 102 may include a substrate 122. The substrate 122 may include, but is not limited to, a transparent substrate, such as a glass substrate, a ceramic substrate, a plastic substrate, or any other suitable transparent substrate. The thin film transistor 110 includes a gate electrode 124 disposed on the substrate 122 and a gate dielectric layer 126 disposed on the gate electrode 124 and the substrate 122. The gate electrode 124 extends out from the scan line 104 along second direction A2.

The material of the gate electrode 124 may include, but is not limited to, amorphous silicon, poly-silicon, one or more metal, metal nitride, conductive metal oxide, or a combination thereof. The metal may include, but is not limited to, molybdenum, tungsten, titanium, tantalum, platinum, or hafnium. The metal nitride may include, but is not limited to, molybdenum nitride, tungsten nitride, titanium nitride or tantalum nitride. The conductive metal oxide may include, but is not limited to, ruthenium oxide or indium tin oxide. The conductive material layer may be formed by the previously described chemical vapor deposition (CVD) process, sputtering, resistive thermal evaporation, electron beam evaporation, or any other suitable method. For example, in one embodiment, the amorphous silicon conductive material layer or poly-silicon conductive material layer may be deposited and formed by low-pressure chemical vapor deposition at about 525° C.˜650° C. The thickness of the amorphous silicon conductive material layer or poly-silicon conductive material layer may range from about 1000 Å to 10000 Å.

The material of the gate dielectric layer 126 may include, but is not limited to, silicon oxide, silicon nitride, silicon oxynitride, high-k material, any other suitable dielectric material, or a combination thereof. The high-k material may include, but is not limited to, metal oxide, metal nitride, metal silicide, transition metal oxide, transition metal nitride, transition metal silicide, transition metal oxynitride, metal aluminate, zirconium silicate, zirconium aluminate. For example, the material of the high-k material may include, but is not limited to, LaO, AlO, ZrO, TiO, Ta₂O₅, Y₂O₃, SrTiO₃(STO), BaTiO₃(BTO), BaZrO, HfO₂, HfO₃, HfZrO, HfLaO, HfSiO, HfSiON, LaSiO, AlSiO, HfTaO, HfTiO, HfTaTiO, HfAlON, (Ba,Sr)TiO₃(BST), Al₂O₃, any other suitable high-k dielectric material, or a combination thereof. The gate dielectric layer may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

The thin film transistors 110 further includes a semiconductor layer 128 disposed on the gate dielectric layer 126. The semiconductor layer 128 overlaps with the gate electrode 124. The source electrode 130 and drain electrode 132 of the thin film transistors 110 are disposed at opposite sides of the semiconductor layer 128, respectively. The source electrode 130 and drain electrode 132 of the thin film transistors 110 overlap with the portions of the semiconductor layer 128 at the opposite sides, respectively. In addition, the source electrode 130 is a portion of the data line 106.

The semiconductor layer 128 may include an element semiconductor which may include silicon, germanium; a compound semiconductor which may include gallium nitride (GaN), silicon carbide, gallium arsenide, gallium phosphide, indium phosphide, indium arsenide and/or indium antimonide; an alloy semiconductor which may include SiGe alloy, GaAsP alloy, AlInAs alloy, AlGaAs alloy, GaInAs alloy, GaInP alloy and/or GaInAsP alloy; or a combination thereof.

The source electrode 130 and drain electrode 132 may include, but is not limited to, copper, aluminum, molybdenum, tungsten, gold, cobalt, nickel, platinum, titanium, iridium, rhodium, an alloy thereof, a combination thereof, or any other conductive material. For example, the source electrode 130 and drain electrode 132 may include three-layered structure such as Mo/Al/Mo or Ti/Al/Ti. In other embodiments, the source electrode 130 and drain electrode 132 includes a nonmetal material. The source electrode 130 and drain electrode 132 may include any conductive material. The material of the source electrode 130 and drain electrode 132 may be formed by chemical vapor deposition (CVD), sputtering, resistive thermal evaporation, electron beam evaporation, or any other suitable method. In some embodiments, the materials of the source electrode 130 and drain electrode 132 may be the same, and the source electrode 130 and drain electrode 132 may be formed by the same deposition steps. However, in other embodiments, the source electrode 130 and drain electrode 132 may be formed by different deposition steps, and the materials of the source electrode 130 and drain electrode 132 may be different from each other.

Still referring to FIG. 2A, the first substrate 102 further includes a first insulating layer 134 covering the transistor 110 and gate dielectric layer 126. The material of the first insulating layer 134 may include, but is not limited to, silicon nitride, silicon oxide, or silicon oxynitride. The first insulating layer 134 may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

In some embodiments of the present disclosure, the touch signal line 118 is disposed on the first insulating layer 134. The touch signal line 118 may include, but is not limited to, copper, aluminum, molybdenum, tungsten, gold, cobalt, nickel, platinum, titanium, iridium, rhodium, an alloy thereof, a combination thereof, or any other conductive material. For example, the touch signal line 118 may include three-layered structure such as Mo/Al/Mo or Ti/Al/Ti. In other embodiments, the touch signal line 118 includes a nonmetal material. The touch signal line 118 may include any conductive material. The material of the touch signal line 118 may be formed by chemical vapor deposition (CVD), sputtering, resistive thermal evaporation, electron beam evaporation, or any other suitable method.

Subsequently, still referring to FIG. 2A, the first substrate 102 may further include a second insulating layer 138 which is disposed on the first insulating layer 134 and covers the touch signal line 118. The material of the second insulating layer 138 may include, but is not limited to, silicon nitride, silicon oxide, or silicon oxynitride. The second insulating layer 138 may have been formed previously by chemical vapor deposition or spin-on coating.

Subsequently, a planarization layer 136 may be optionally disposed on the second insulating layer 138. The material of the planarization layer 136 may include, but is not limited to, organic insulating materials (such as photosensitive resins) or inorganic insulating materials (such as silicon nitride, silicon oxide, silicon oxynitride, silicon carbide, aluminum oxide, or a combination thereof).

The sensing electrodes 112 (or the sub-sensing electrode 112S) are disposed on the planarization layer 136, as shown in FIG. 2A. The material of the sensing electrodes 112 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide. In addition, in other embodiments, the sensing electrodes 112 may include transparent conductive material layer formed by the nano silver yarn. In addition, the sensing electrodes 112 not only serve as the sensing electrode when the display device is touched, but they also serve as the common electrode of the display device. In some embodiments, the driving method for touch-control may include the self-capacitive type. The touch-control transmit electrode (Tx) and touch-control receive electrode (Rx) are both sensing electrodes 112. In addition, the sensing electrodes 112 may be electrically connected to the touch signal line 118 at the sub-sensing electrode 112S, as shown in FIG. 1B.

Still referring to FIG. 2A, the first substrate 102 further include a third insulating layer 140 disposed on the planarization layer 136 and covering the sensing electrodes 112. The material of the third insulating layer 140 may include, but is not limited to, silicon nitride, silicon oxide, or silicon oxynitride. The second insulating layer 138 may be formed by previous chemical vapor deposition or spin-on coating.

In addition, the first substrate 102 includes opening 142. The opening 142 extends downward from the top surface 140S of the third insulating layer 140 to the drain electrode 132 and exposes a portion of the surface 132S of the drain electrode 132.

The first substrate 102 further includes a pixel electrode 144 disposed on the third insulating layer 140 and electrically connected to the drain electrode 132. In particular, the pixel electrode 144 is disposed on a portion of the third insulating layer 140 and extends into the opening 142 to electrically connect the drain electrode 132.

In addition, still referring to FIG. 2A, display device 100 further includes a second substrate 148 disposed opposite the first substrate 102 and a display medium 150 disposed between the first substrate 102 and the second substrate 148. The display medium 150 may include liquid crystal, organic light-emitting diode (OLED), inorganic light-emitting diode (LED) or electro-phoretic particle.

The display device 100 may include, but is not limited to, a touch liquid-crystal display such as a thin film transistor liquid-crystal display. The liquid-crystal display may include, but is not limited to, a twisted nematic (TN) liquid-crystal display, a super twisted nematic (STN) liquid-crystal display, a double layer super twisted nematic (DSTN) liquid-crystal display, a vertical alignment (VA) liquid-crystal display, an in-plane switching (IPS) liquid-crystal display, a cholesteric liquid-crystal display, a blue phase liquid-crystal display, fringe field switching liquid-crystal display, or any other suitable liquid-crystal display. In some other embodiments of the present disclosure, the display device 100 may include organic light-emitting diode display, inorganic light-emitting diode display or electro-phoretic display.

In some embodiments, the second substrate 148 serves as a color filter substrate. In particular, the second substrate 148, which serves as a color filter substrate, may include a substrate 152, light-shielding layers 154 disposed on the substrate 152, a color filter layer 156 disposed between the light-shielding layers 154, and a planarization layer 158 covering the light-shielding layer 154 and the color filter layer 156.

The substrate 152 may include a transparent substrate such as a glass substrate, a ceramic substrate, a plastic substrate, or any other suitable transparent substrate. The light-shielding layer 154 may include, but is not limited to, black photoresist, black printing ink, black resin. The color filter layer 156 may include a red color filter layer, a green color filter layer, a blue color filter layer, or any other suitable color filter layer.

The display device 100 further includes a spacer 160 disposed between the first substrate 102 and second substrate 148. The spacer 160 is the main structure used to space the first substrate 102 apart from the second substrate 148 to prevent the first substrate 102 from touching the second substrate 148 when the display device 100 is pressed or touched and to keep a constant distance between the first substrate 102 and second substrate 148.

As shown in FIG. 2A, the opening 114 of the present disclosure is disposed corresponding to the data lines 106 (i.e. the source electrode 130 shown in FIG. 2A). Therefore, most regions in the sensing electrodes 112 and at the edge of the sensing electrode 112 corresponding to the data lines 106 have the opening 114. Thereby, the electric field distribution at most of the inner portion of the sensing electrode 112 may be similar to the electric field distribution at the edge of the sensing electrode 112. Therefore, the capacitance between the inner portion of the sensing electrode 112 and the other elements may be similar to the capacitance between the edge of the sensing electrode 112 and the other elements, which in turn reduces light leakage in the display device 100 and improves the display quality. On the other hand, since the overlap between the sensing electrode 112 and the scan lines 104 or data lines 106 is decreased, the parasitic capacitance between the sensing electrode 112 and the scan line 104 or data line 106 may be reduced, which in turn improves the image and touch-control performance.

It should be noted that the exemplary embodiment set forth in FIG. 2A is merely for the purpose of illustration. In addition to the embodiment set forth in FIG. 2A, the common electrode, pixel electrode and touch signal line of the present disclosure may have other configurations as shown in FIG. 2B. This will be described in detail in the following description. Therefore, the inventive concept and scope are not limited to the exemplary embodiment shown in FIG. 2A.

Note that the same or similar elements or layers corresponding to those of the display device are denoted by like reference numerals. The same or similar elements or layers denoted by like reference numerals have the same meaning and will not be repeated for the sake of brevity.

FIG. 2B is a cross-sectional view of a display device 200 in accordance with another embodiment of the present disclosure. As shown in FIG. 2B, the first substrate 102 may include a substrate 122. The thin film transistor 110 includes a gate electrode 124 disposed on the substrate 122 and a gate dielectric layer 126 disposed on the gate electrode 124 and the substrate 122. The gate electrode 124 extends out from the scan line 104 along second direction A2.

The thin film transistors 110 further include a semiconductor layer 128 disposed on the gate dielectric layer 126. The semiconductor layer 128 overlaps with the gate electrode 124. The source electrode 130 and drain electrode 132 of the thin film transistors 110 are disposed at opposite sides of the semiconductor layer 128, respectively. The source electrode 130 and drain electrode 132 of the thin film transistors 110 overlap with the portions of the semiconductor layer 128 at the opposite sides, respectively. In addition, the source electrode 130 is a portion of the data line 106.

Still referring to FIG. 2B, the first substrate 102 further includes a first insulating layer 134 covering the transistor 110 and gate dielectric layer 126. The material of the first insulating layer 134 may include, but is not limited to, silicon nitride, silicon oxide, or silicon oxynitride. The first insulating layer 134 may be formed by chemical vapor deposition or spin-on coating.

Subsequently, a planarization layer 136 may be optionally disposed on the second insulating layer 138. The material of the planarization layer 136 may include, but is not limited to, organic insulating materials (such as photosensitive resins) or inorganic insulating materials (such as silicon nitride, silicon oxide, silicon oxynitride, silicon carbide, aluminum oxide, or a combination thereof).

The first substrate 102 further includes a pixel electrode 144 disposed on the planarization layer 136 and electrically connected to the drain electrode 132. In particular, the pixel electrode 144 is disposed on a portion of the planarization layer 136 and extends into the opening 142 to electrically connect the drain electrode 132.

The touch signal line 118 is disposed on the planarization layer 136. The touch signal line 118 may include, but is not limited to, copper, aluminum, molybdenum, tungsten, gold, cobalt, nickel, platinum, titanium, iridium, rhodium, an alloy thereof, a combination thereof, or any other conductive material. For example, the touch signal line 118 may include three-layered structure such as Mo/Al/Mo or Ti/Al/Ti. In other embodiments, the touch signal line 118 includes a nonmetal material. The touch signal line 118 may include any conductive material.

Subsequently, still referring to FIG. 2B, the first substrate 102 may further include a second insulating layer 138 which is disposed on the planarization layer 136 and covers the pixel electrode 144. The material of the second insulating layer 138 may include, but is not limited to, silicon nitride, silicon oxide, or silicon oxynitride. The second insulating layer 138 may have been formed previously by chemical vapor deposition or spin-on coating.

The sensing electrodes 112 (or sub-sensing electrode 112S) are disposed on the second insulating layer 138, as shown in FIG. 2B. The material of the sensing electrodes 112 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide. In addition, in other embodiments, the sensing electrodes 112 may include transparent conductive material layer formed by the nano silver yarn. In addition, the sensing electrodes 112 not only serve as the sensing electrode when the display device is touched, but also serves as the common electrode of the display device. In some embodiments, the driving method for touch-control may include the self-capacitive type. The touch-control transmit electrode (Tx) and touch-control receive electrode (Rx) are both sensing electrodes 112. In addition, the sensing electrodes 112 may be electrically connected to the touch signal line 118 at the sub-sensing electrode 112S, as shown in FIG. 1B.

In addition, still referring to FIG. 2B, the display device 100 further includes a second substrate 148 disposed opposite the first substrate 102 and a display medium 150 disposed between the first substrate 102 and the second substrate 148. The display medium 150 may include liquid crystal, organic light-emitting diode (OLED), inorganic light-emitting diode (LED) or electro-phoretic particle.

In some embodiments, the second substrate 148 serves as a color filter substrate. In particular, the second substrate 148, which serves as a color filter substrate, may include a substrate 152, light-shielding layers 154 disposed on the substrate 152, a color filter layer 156 disposed between the light-shielding layers 154, and a planarization layer 158 covering the light-shielding layer 154 and the color filter layer 156.

As shown in FIG. 2B, the opening 114 of the present disclosure is disposed corresponding to the data lines 106 (i.e. the source electrode 130 shown in FIG. 2B). Therefore, most regions in the sensing electrodes 112 and at the edge of the sensing electrode 112 corresponding to the data lines 106 have an opening 114. Thereby, the electric field distribution at most of the inner portion of the sensing electrode 112 may be similar to the electric field distribution at the edge of the sensing electrode 112. Therefore, the capacitance between the inner portion of the sensing electrode 112 and the other elements may be similar to the capacitance between the edge of the sensing electrode 112 and the other elements, which in turn reduces light leakage in the display device 200 and improves the display quality. On the other hand, since the overlap between the sensing electrode 112 and the scan lines 104 or data lines 106 is decreased, the parasitic capacitance between the sensing electrode 112 and the scan line 104 or data line 106 may be reduced, which in turn improves the image and touch-control performance.

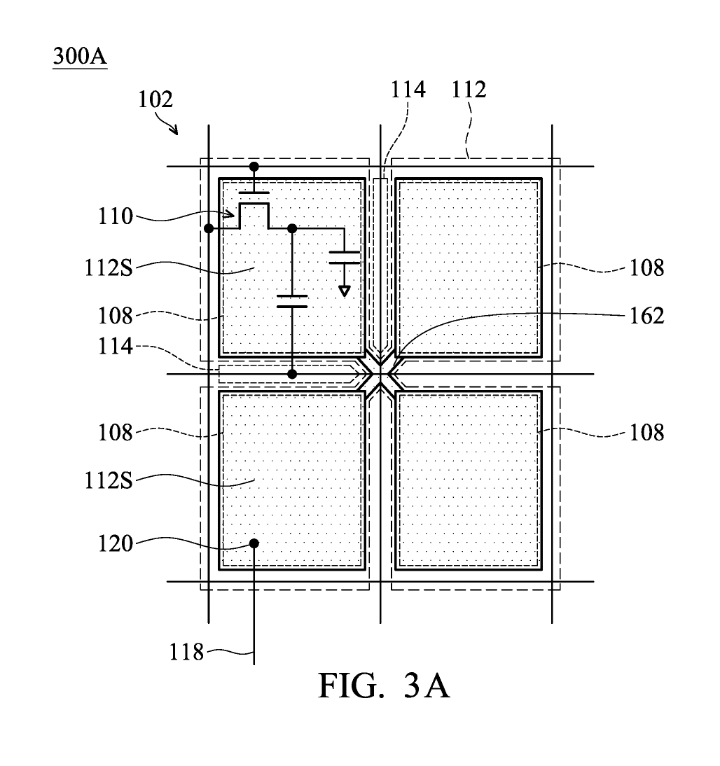

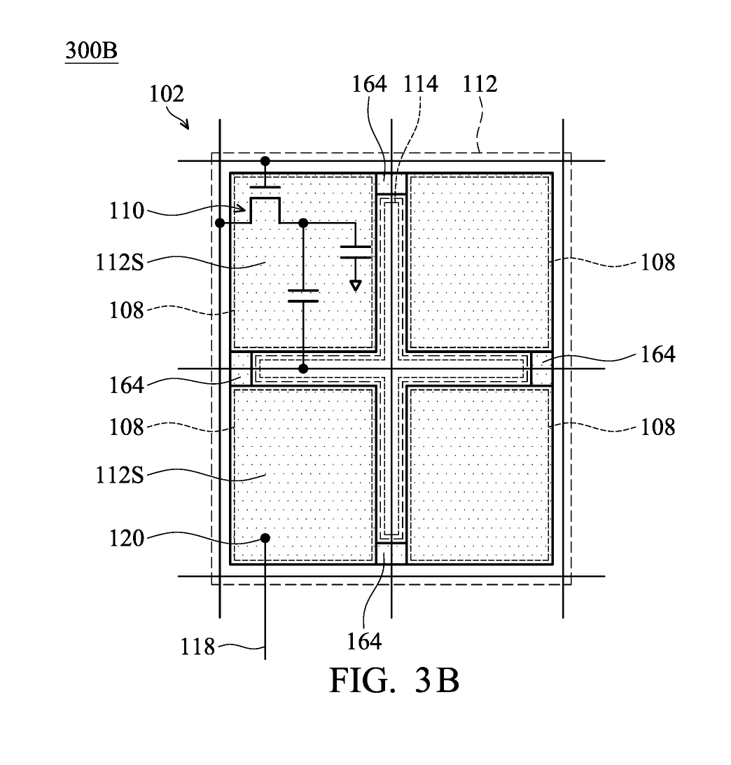

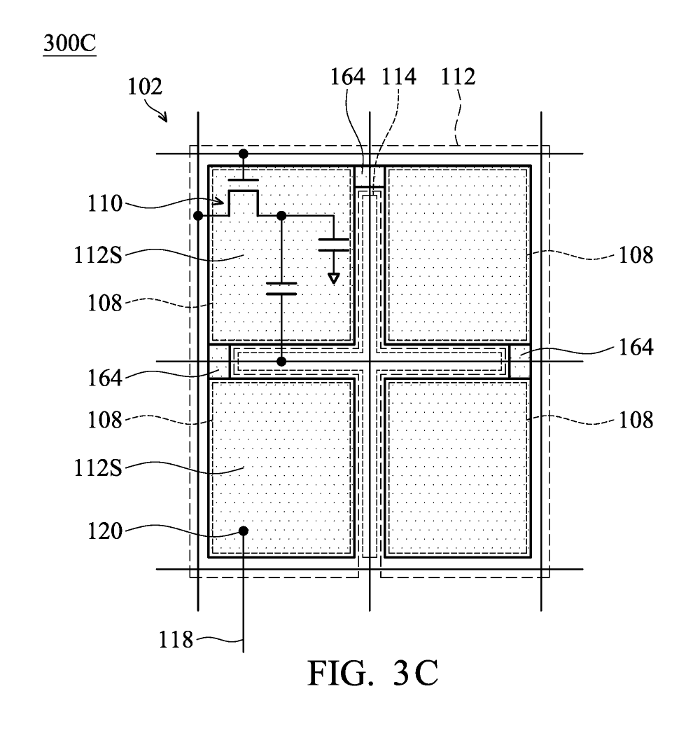

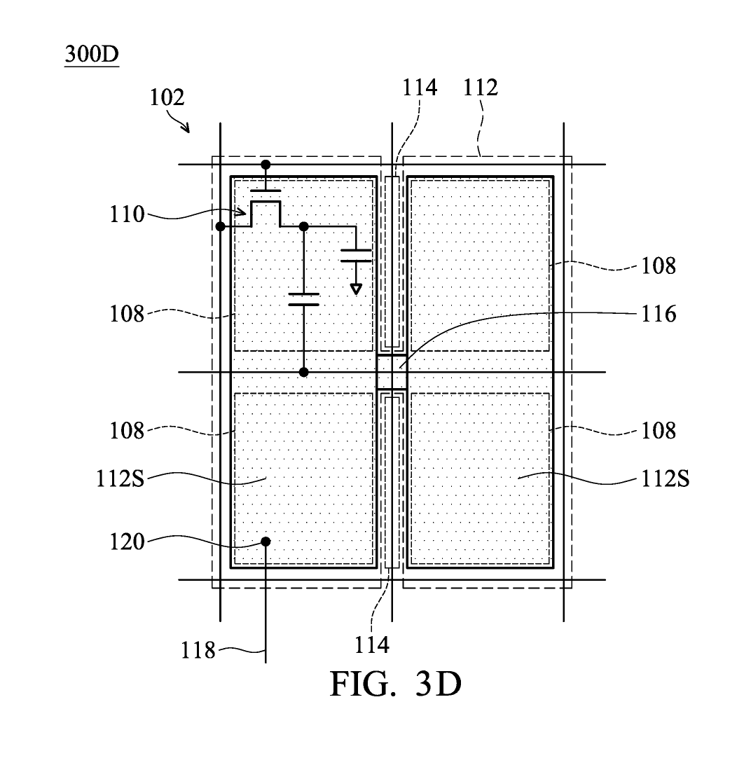

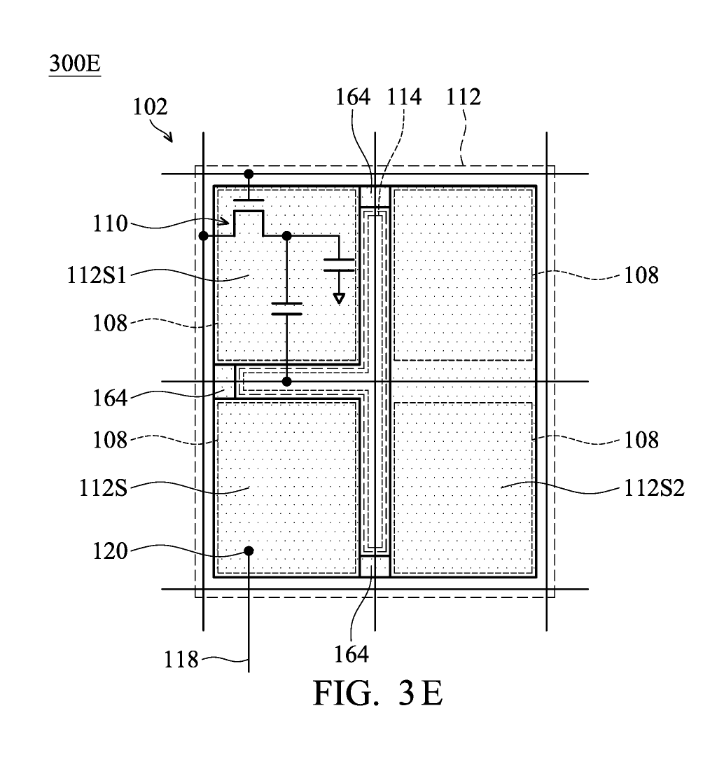

FIG. 3A is a top view of a first substrate 102 of a display device 300A in accordance with another embodiment of the present disclosure. The difference between the embodiment shown in FIG. 3A and the embodiment shown in FIGS. 1A-1B is that the connection portion 162 of the sensing electrodes 112 is polygon-shaped. The opening 114 is an extending branch of the first spacing G1 or second spacing G2. The opening 114 connects to the first spacing G1 or second spacing G2. Note that the same or similar elements or layers corresponding to those of the display device are denoted by like reference numerals. The same or similar elements or layers denoted by like reference numerals have the same meaning and will not be repeated for the sake of brevity.

FIG. 3B is a top view of a first substrate 102 of a display device 300B in accordance with another embodiment of the present disclosure. The difference between the embodiment shown in FIG. 3B and the embodiment shown in FIG. 3A is that the connection portion 164 is disposed at a periphery of the sensing electrode 112. The opening 114 is disposed in the sensing electrode 112. In addition, the connection portion 164 is disposed between the opening 114 and the first spacing G1 or second spacing G2. In some embodiments of the present disclosure, the opening 114 does not connect to the first spacing G1 or second spacing G2. However, in some other embodiments of the present disclosure, the opening 114 may partially connect to the first spacing G1 or second spacing G2. The amount of the connection portion 164 is not limited to that shown in FIG. 3B. The amount of the connection portion 164 may be adjusted according to requirements, as shown in FIG. 3C.

FIG. 3C is a top view of a first substrate 102 of a display device 300C in accordance with another embodiment of the present disclosure. The difference between the embodiments shown in FIGS. 3C and 3B is that the connection portion 164 is only disposed at peripheries of three sides of the sensing electrode 112. In other words, the opening 114 may connect to one of the first spacing G1 of the sensing electrode 112. The opening 114 does not connect to the other first spacing G1 and second spacing G2 which are adjacent to the sensing electrode 112 due to the connection portion 164 disposed between the opening 114 and the other first spacing G1 or second spacing G2.

FIG. 3D is a top view of a first substrate 102 of a display device 300D in accordance with another embodiment of the present disclosure. The difference between the embodiments shown in FIGS. 3D and 3A is that each of the sub-sensing electrodes 112S is disposed corresponding to a plurality of sub-pixels 108. For example, each of the sub-sensing electrodes 112S is disposed corresponding to two sub-pixels 108. In other embodiments, each of the sub-sensing electrodes 112S may be disposed corresponding to another amount of sub-pixels 108 respectively, and may be electrically connected to each other through the connection portion. There is an opening 114 disposed corresponding to the scan lines 104 or data lines 106.

FIG. 3E is a top view of a first substrate 102 of a display device 300E in accordance with another embodiment of the present disclosure. The difference between the embodiments shown in FIGS. 3E and 3A is that at least one sub-sensing electrode 112S is disposed corresponding to one sub-pixel 108, and at least one other sub-sensing electrode 112S is disposed corresponding to a plurality of sub-pixels 108.

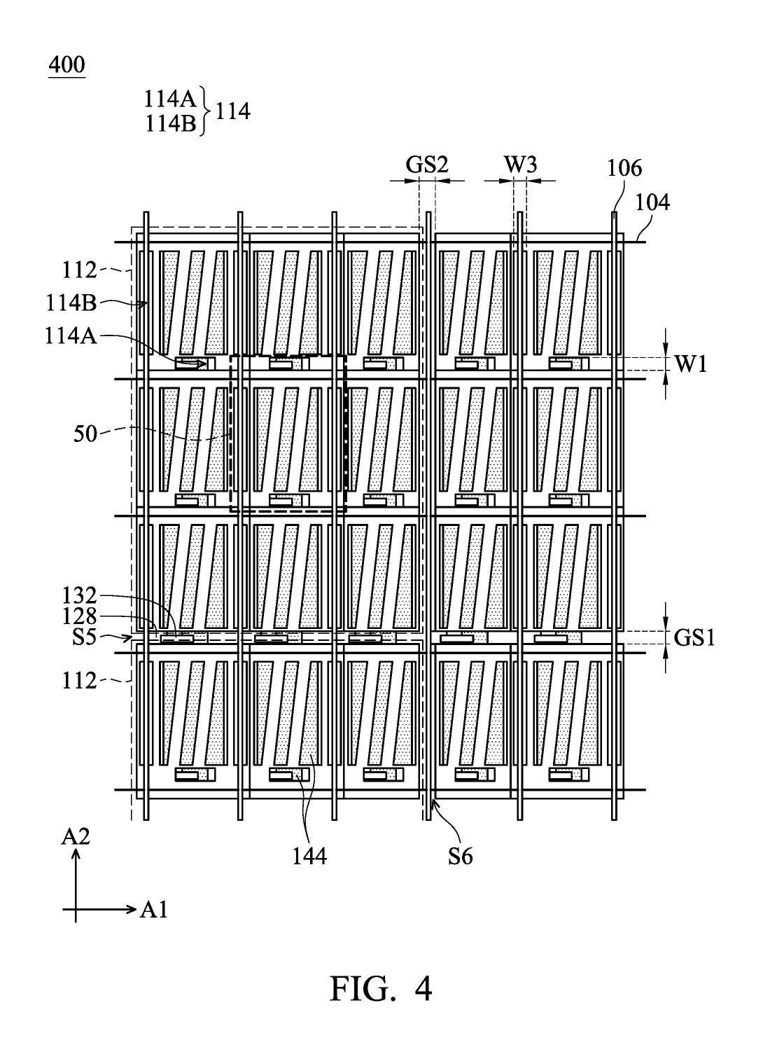

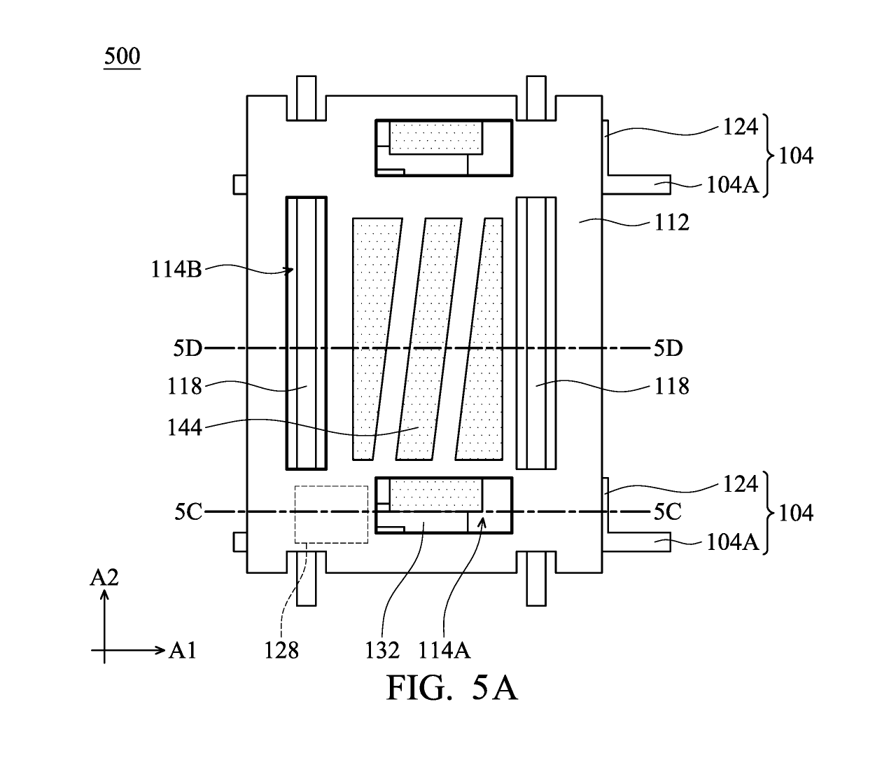

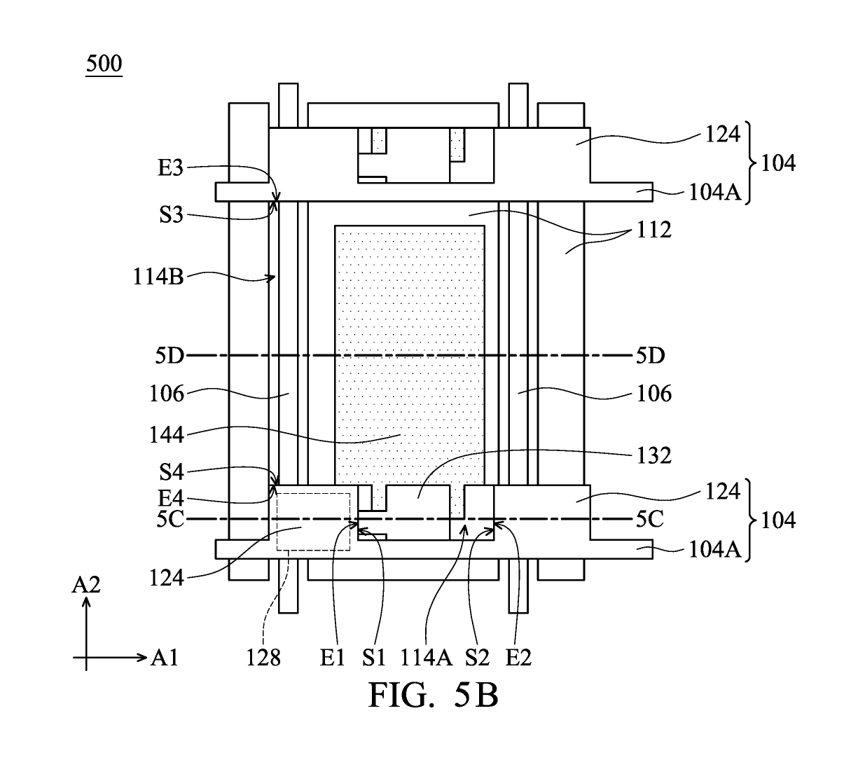

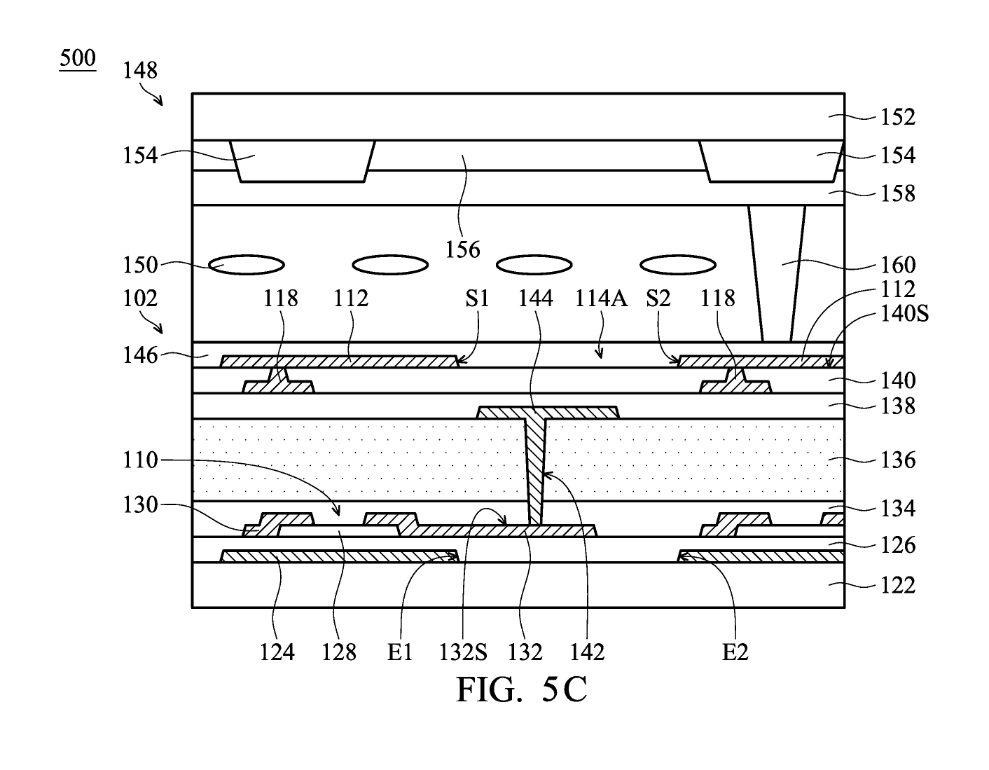

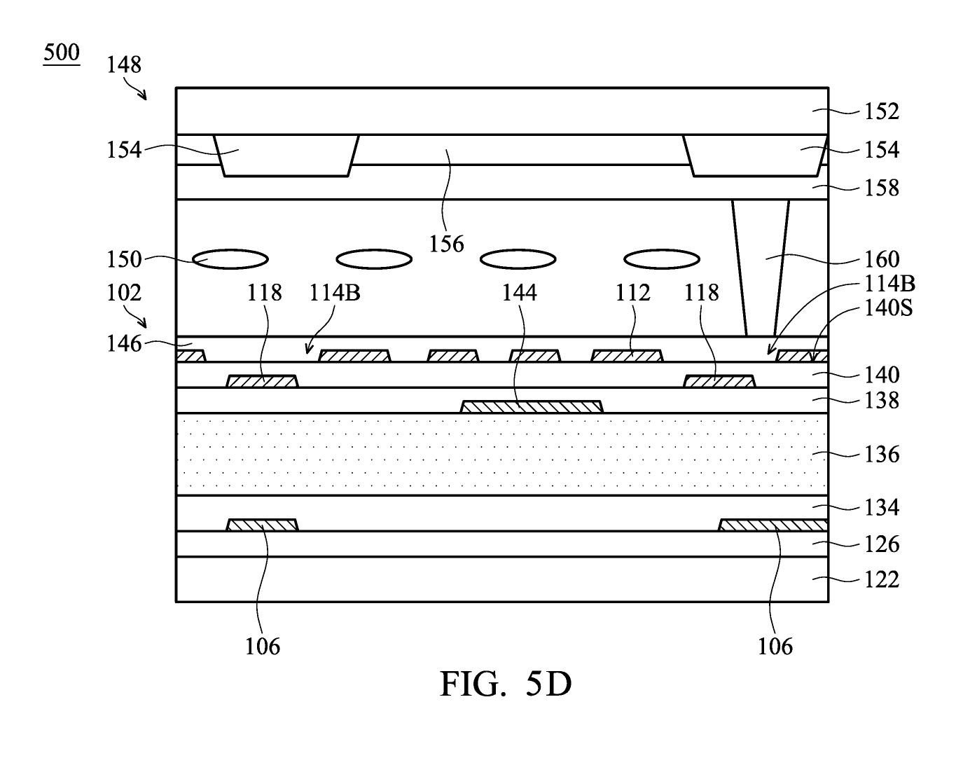

FIG. 4 is a top view of a display device 400 in accordance with another embodiment of the present disclosure. FIG. 5A is a top view and a partially enlarged figure of the region 50 of the display device 400 in FIG. 4. FIG. 5B is a bottom view and a partially enlarged figure of the region 50 of the display device 400 in FIG. 4. As shown in FIGS. 4-5B, the scan line 104 includes a main line portion 104A and a plurality of gate electrodes 124 extending out from the main line portion 104A along direction A2.

Note that the same or similar elements or layers are denoted by like reference numerals. The same or similar elements or layers denoted by like reference numerals have the same meaning and will not be repeated for the sake of brevity.

As shown in FIGS. 4-5B, at least one sensing electrode 112 has a plurality of openings 114, and the plurality of openings 114 includes a first-direction opening 114A and a second-direction opening 114B. Note that the first direction A1 is the extending direction of the main line portion 104A of the scan line 104, and the second direction A2 is the extending direction of the data line 106.

Still referring to FIGS. 4-5B, the first-direction opening 114A is disposed corresponding to the region between two adjacent gate electrodes 124, and the second-direction opening 114B is disposed corresponding to one of the data lines 106. In other embodiments, the first-direction opening 114A may expose the main line portion 104A of a portion of the scan line 104. The portion of the scan line 104 refers to the region where the sensing electrode 112 does not overlap with the main line portion 104A of the scan line 104.

In addition, in the embodiment wherein the touch signal line 118 substantially overlaps with the data line 106, the second-direction opening 114B is also disposed corresponding to the touch signal line 118.

The embodiments of the present disclosure have the first-direction opening 114A disposed corresponding to the region between two adjacent gate electrodes 124, and have the second-direction opening 114B disposed corresponding to one of the data lines 106. Therefore, most regions in the sensing electrodes 112 and at the edge of the sensing electrode 112 corresponding to the scan lines 104 or data lines 106 have the opening 114. Thereby, the electric field distribution at most of the inner portion of the sensing electrode 112 may be similar to the electric field distribution at the edge of the sensing electrode 112. Furthermore, the capacitances between the inner portion of the sensing electrode 112 and the other elements may be similar to the capacitances between the edge of the sensing electrode 112 and the other elements. That is, both two designs decline the differences between the region and edge of the sensing electrode 112. Moreover, the image and touch-control performances may be improved at which the parasitic capacitances between the sensing electrode 112 and the scan line 104, data line 106 or the touch signal line 118 are reduced due to the decrease in the overlap region between the sensing electrode 112 and the scan lines 104, data lines 106 or the touch signal line 118.

In addition, in some embodiments, two adjacent sensing electrodes 112 are separated apart by a first spacing S5 and a second spacing S6. The width W1 of the first-direction opening 114A is equal to the first distance GS1 of the first spacing S5 along the second direction A2, as shown in FIG. 4. Regarding the array of sensing electrode 112, this design could afford to alleviate differences between adjacent sensing electrodes 112. Thereby, light leakage and display quality in the display device 500 are improved radically.

In addition, in some embodiments, two sides S1 and S2 of the first-direction opening 114A are separated from each other along the first direction A1 and respectively aligned to the edges E1 and E2 of the two gate electrodes 124, in the first direction A1, to which the first-direction opening 114A corresponds, as shown in FIGS. 5A and 5B.

In other embodiments, along the first direction A1, the distance between the two sides S1 and S2 may be smaller than or greater than the distance between the edges E1 and E2. In some embodiments, the side S1 may align to the edge E1, whereas the side S2 may not align to the edge E2. Alternatively, in some other embodiments, the side S2 may align to the edge E2, whereas the side S1 may not align to the edge E1. Alternatively, in some other embodiments, the side S1 may not align to the edge E1, and the side S2 may not align to the edge E2.

In addition, in some embodiments, the second-direction opening 114B is disposed between two adjacent scan lines 104. In addition, in some embodiments, the width W3 of the second-direction opening 114B is the same as the second distance GS2 of the second spacing G2 along the first direction A1. Regarding the array of sensing electrode 112, this design could afford to alleviate differences between adjacent sensing electrodes 112. Thereby, light leakage and display quality in the display device 500 are improved radically.

In addition, in some embodiments, the two sides S3 and S4 of the second-direction opening 114B are separated from each other along the second direction A2 and respectively aligned to the edges E3 and E4 of the two scan lines 104, in the second direction A2, to which the second-direction opening 114B corresponds, as shown in FIG. 5B.

In other embodiments, along the second direction A2, the distance between the two sides S3 and S4 may be smaller than or greater than the distance between the edges E3 and E4. In some embodiments, the side S3 may align to the edge E3, whereas the side S4 may not align to the edge E4. Alternatively, in some other embodiments, the side S4 may align to the edge E4, whereas the side S3 may not align to the edge E3. Alternatively, in some other embodiments, the side S3 may not align to the edge E3, and the side S4 may not align to the edge E4.

FIG. 5C is a cross-sectional view along line 5C-5C in FIGS. 5A-5B in accordance with some embodiments of the present disclosure. FIG. 5D is a cross-sectional view along line 5D-5D in FIGS. 5A-5B in accordance with some embodiments of the present disclosure. Note that the same or similar elements or layers are denoted by like reference numerals. The same or similar elements or layers denoted by like reference numerals have the same meaning and will not be repeated for the sake of brevity.

As shown in FIGS. 5C-5D, the embodiments of the present disclosure have the first-direction opening 114A be disposed corresponding to the region between two adjacent gate electrodes 124, and have the second-direction opening 114B be disposed corresponding to one of the data line 106. Therefore, most regions in the sensing electrodes 112 and at the edge of the sensing electrode 112 corresponding to the scan lines 104 or data lines 106 have the opening 114. Thereby, the electric field distribution at most of the inner portion of the sensing electrode 112 may be similar to the electric field distribution at the edge of the sensing electrode 112. Therefore, the capacitances between the inner portion of the sensing electrode 112 and the other elements may be similar to the capacitances between the edge of the sensing electrode 112 and the other elements, which reduces light leakage in the display device 500 and improves the display quality in turn. Moreover, the image and touch-control performances may be improved at which the parasitic capacitances between the sensing electrode 112 and the scan line 104, data line 106 or the touch signal line 118 are reduced due to the decrease in the overlap region between the sensing electrode 112 and the scan lines 104, data lines 106 or the touch signal line 118.

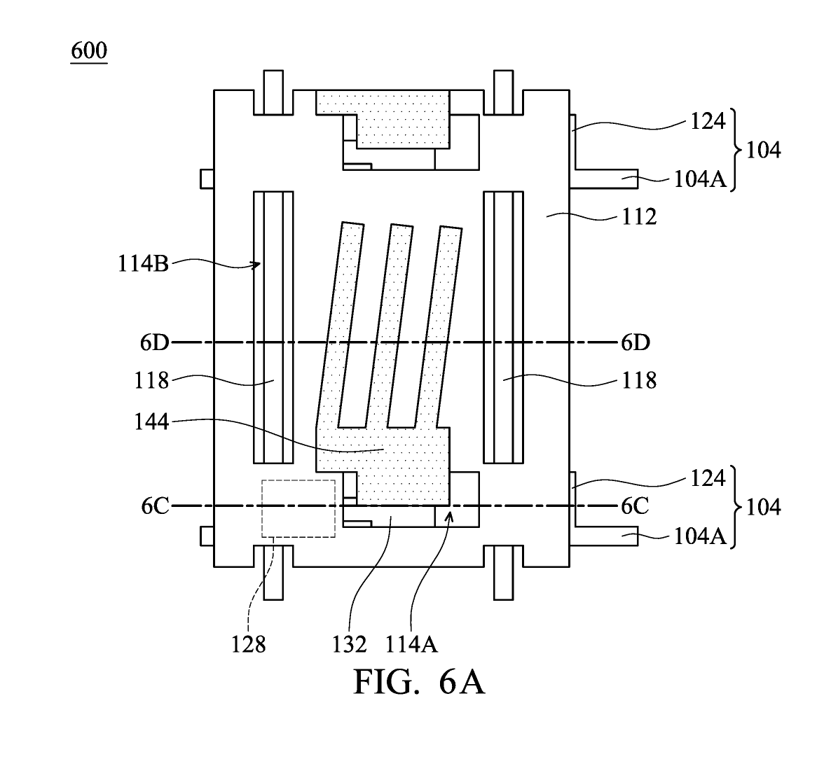

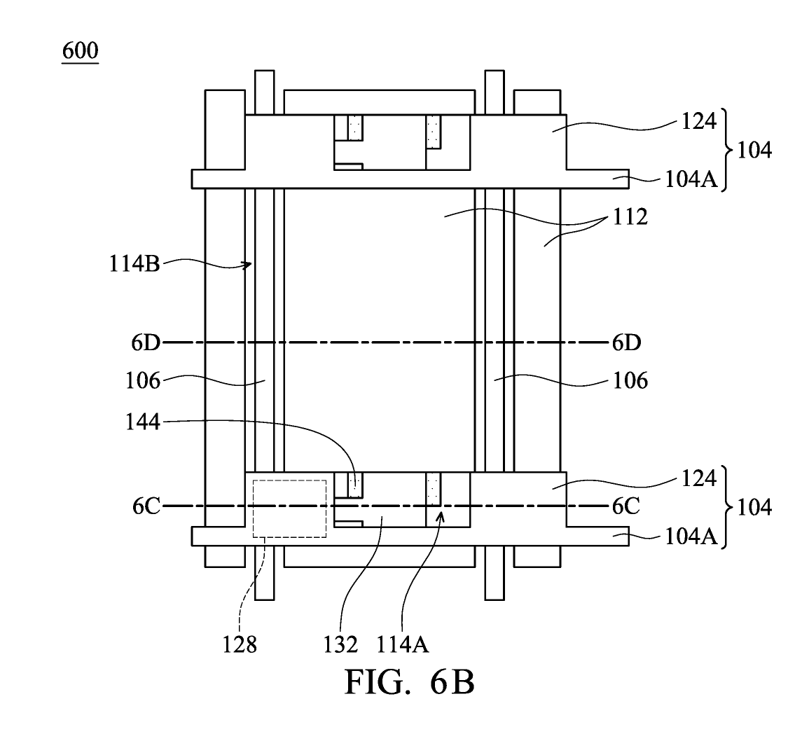

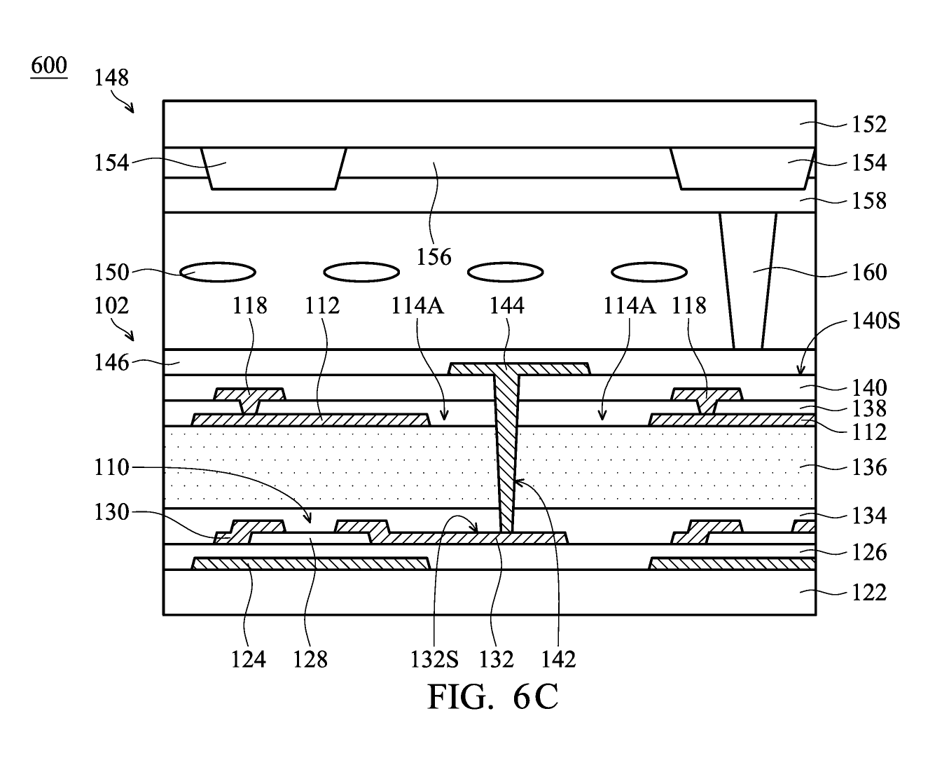

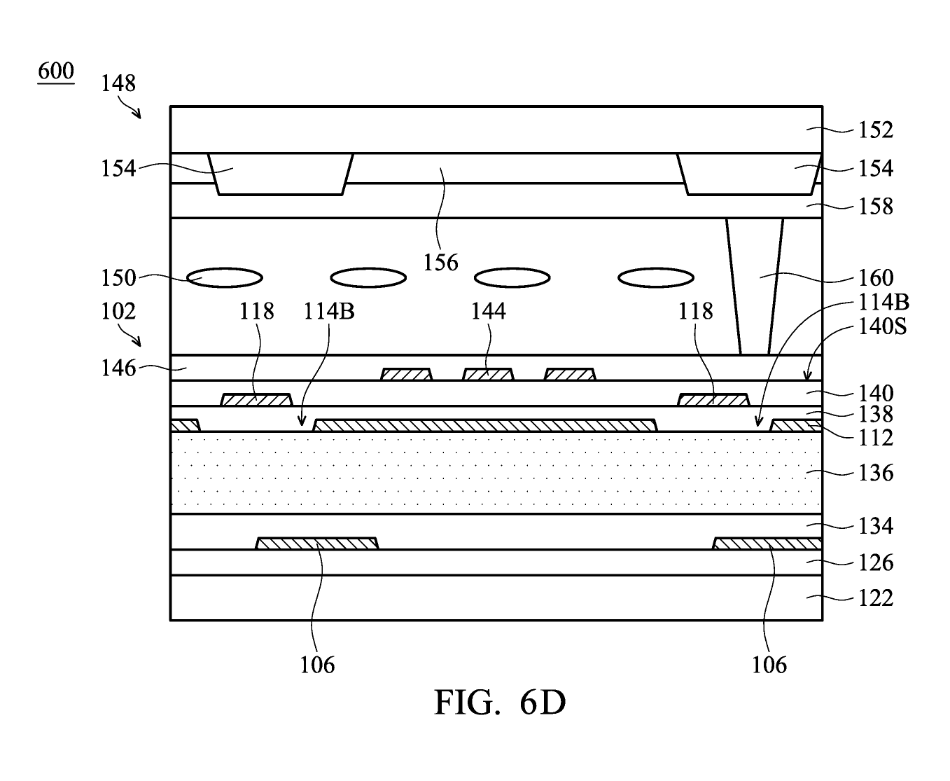

It should be noted that the exemplary embodiments set forth in FIGS. 5A-5D are merely for the purpose of illustration. In addition to the embodiments set forth in FIGS. 5A-5D, the sensing electrode, pixel electrode and touch signal line of the present disclosure may have other configurations as shown in FIGS. 6A-6D. This will be described in detail in the following description. Therefore, the inventive concept and scope are not limited to the exemplary embodiments shown in FIGS. 5A-5D.

FIGS. 6A-6D is a display device 600 in accordance with some embodiments of the present disclosure. FIG. 6A is a top view of the display device 600. FIG. 6B is a bottom view of the display device 600. FIG. 6C is a cross-sectional view along line 6C-6C in FIGS. 6A-6B in accordance with some embodiments of the present disclosure. FIG. 6D is a cross-sectional view along line 6D-6D in FIGS. 6A-6B in accordance with some embodiments of the present disclosure. Note that the same or similar elements or layers are denoted by like reference numerals. The same or similar elements or layers denoted by like reference numerals have the same meaning and will not be repeated for the sake of brevity.

The manifest difference between the embodiments shown in FIGS. 6A-6D (similar to FIG. 2A) and FIGS. 5A-5D (similar to FIG. 2B) is that when observed from a top view, the pixel electrode is disposed on the sensing electrode in FIGS. 6A-6D, and the pixel electrode is disposed below the sensing electrode in FIGS. 5A-5D. In addition, as shown in FIGS. 6A-6D, the embodiments of the present disclosure have the first-direction opening 114A be disposed corresponding to the region between two adjacent gate electrodes 124 and have the second-direction opening 114B be disposed corresponding to one of the data line 106. Therefore, most regions in the sensing electrodes 112 and at the edge of the sensing electrode 112 corresponding to the scan lines 104 or data lines 106 have the opening 114. Thereby, the electric field distribution at most of the inner portion of the sensing electrode 112 may be similar to the electric field distribution at the edge of the sensing electrode 112. Therefore, the capacitance between the inner portion of the sensing electrode 112 and the other elements may be similar to the capacitance between the edge of the sensing electrode 112 and the other elements, which reduces light leakage in the display device 600 and improves the display quality in turn. Moreover, the image and touch-control performances may be improved at which the parasitic capacitances between the sensing electrode 112 and the scan line 104, data line 106 or the touch signal line 118 are reduced due to the decrease in the overlap region between the sensing electrode 112 and the scan lines 104, data lines 106 or the touch signal line 118.

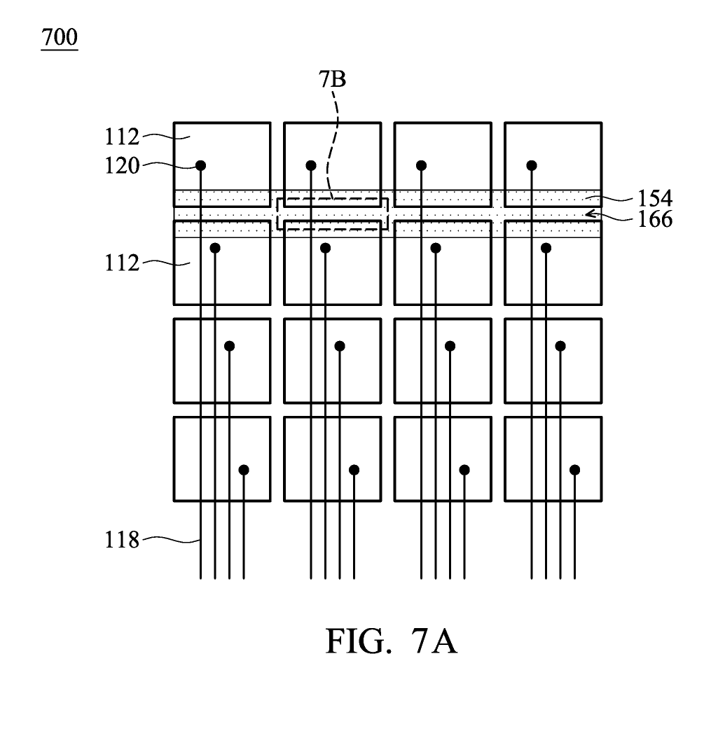

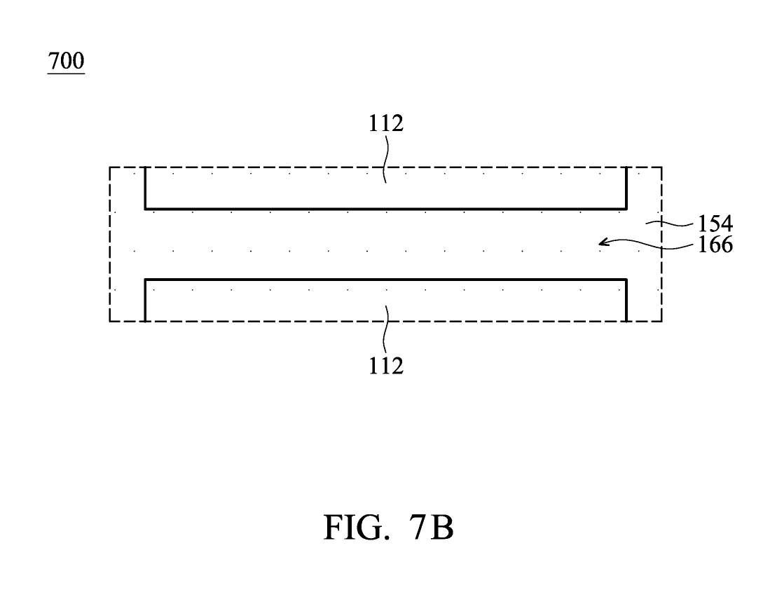

FIG. 7A is a top view of a display device 700 in accordance with another embodiment of the present disclosure. FIG. 7B is a partially enlarged figure of the region 7B of the display device 700 in FIG. 7A. Note that the same or similar elements or layers are denoted by like reference numerals. The same or similar elements or layers denoted by like reference numerals have the same meaning and will not be repeated for the sake of brevity.

As shown in FIGS. 7A-7B, the spacing 166 between the two adjacent sensing electrodes 112 is disposed corresponding to the light-shielding layer 154. By disposing the spacing 166 corresponding to the light-shielding layer 154, the region in the device where the light leakage might occur (i.e. the region to which the spacing 166 corresponds) are shielded by the light-shielding layer 154, which in turn improves the display quality.

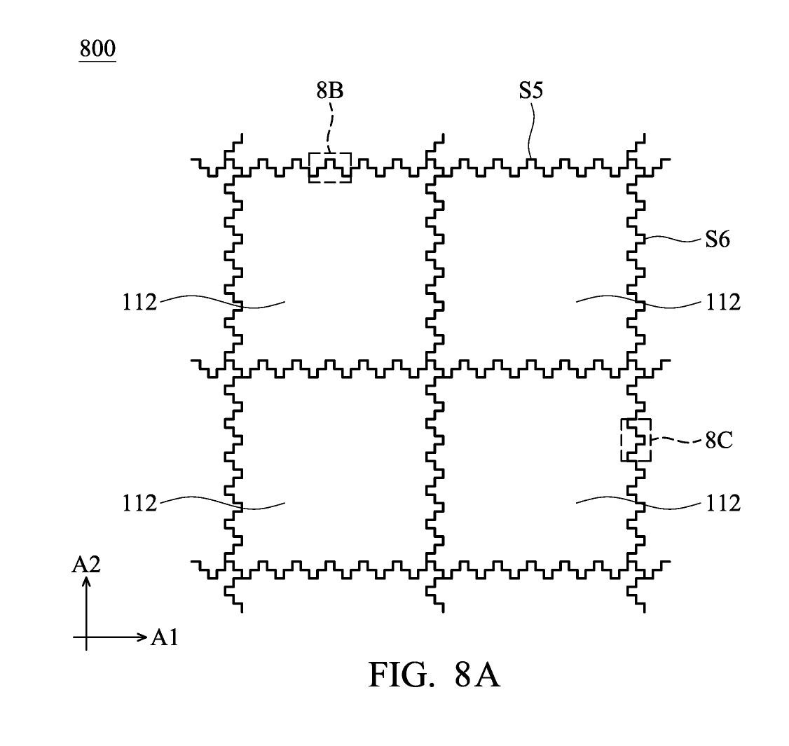

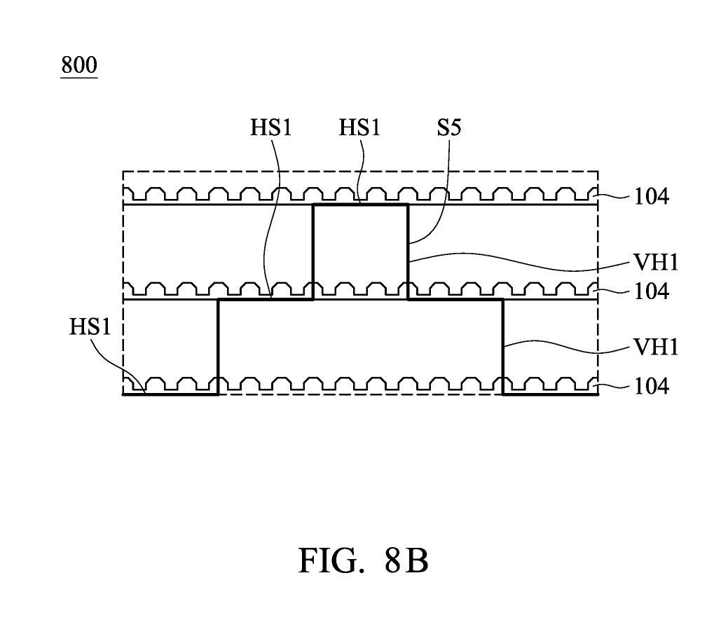

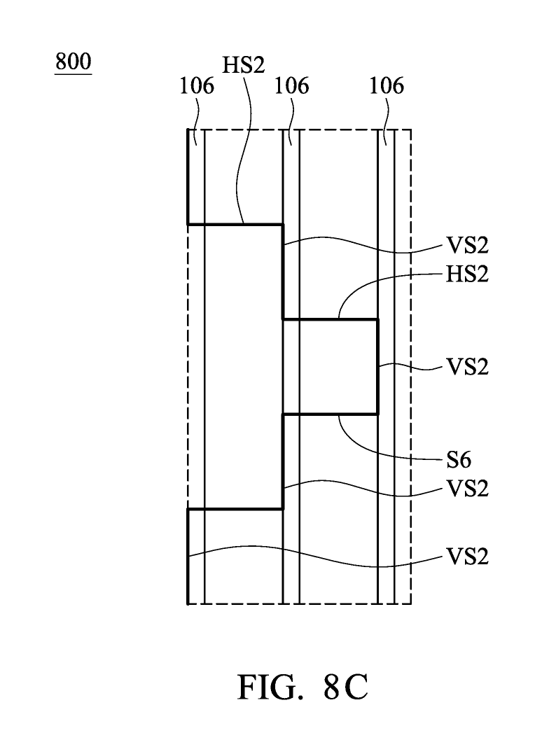

FIG. 8A is a top view of a display device 800 in accordance with another embodiment of the present disclosure. FIG. 8B is a partially enlarged figure of the region 8B of the display device 800 in FIG. 8A. FIG. 8C is a partially enlarged figure of the region 8C of the display device 800 in FIG. 8A. Note that the same or similar elements or layers corresponding to those of the display device are denoted by like reference numerals. The same or similar elements or layers denoted by like reference numerals have the same meaning and will not be repeated for the sake of brevity.

As shown in FIGS. 8A-8C, the first spacing S5 which extends along the first direction A1 is disposed corresponding to the plurality of scan lines 104, and the second spacing S6 which extends along the second direction A2 is disposed corresponding to the plurality of data lines 106.

In this embodiment, the first spacing S5 includes a plurality of first portions HS1 extending along the first direction A1 and a plurality of second portions VS1 extending along the second direction A2. The first portions HS1 are disposed corresponding to the scan lines 104, and the second portions VS1 are disposed corresponding to the data lines 106. The first portion HS1 may correspond to the width of at least one pixel 108 along the first direction A1. The second portion VS1 may correspond to the width of at least one pixel 108 along the second direction A2. The first portions HS1 and second portions VS1 connect to each other to form the first spacing S5.

In this embodiment, the second spacing S6 includes a plurality of third portions HS2 extending along the first direction A1 and a plurality of fourth portions VS2 extending along the second direction A2. The third portions HS2 are disposed corresponding to the scan lines 104, and the fourth portions VS2 are disposed corresponding to the data lines 106. The third portion HS2 may correspond to the width of at least one pixel 108 along the first direction A1. The fourth portion VS2 may correspond to the width of at least one pixel 108 along the second direction A2. The third portions HS2 and fourth portions VS2 connect to each other to form the second spacing S6.

However, in some other embodiments of the present disclosure, the configuration of the first spacing S5 and second spacing S6 is not limited to that shown in FIG. 8A. In some other embodiments of the present disclosure, only one of the first spacing S5 or second spacing S6 includes two portions which correspond to the scan lines 104 and data lines 106 respectively.

In some embodiments of the present disclosure, the first spacing S5 extending along the first direction A1 is disposed corresponding to 3-10 of the scan lines 104. The two first portions HS1 at the two edges of the first spacing S5 along the second direction A2 are spaced apart by 3-10 of the scan lines 104. In addition, the second spacing S6 extending along the second direction A2 is disposed corresponding to 3-10 of the data lines 106. The two fourth portions VS2 at the two edges of the second spacing S6 along the first direction A1 are spaced apart by 3-10 of the data lines 106.

Since the first spacing S5 between two sensing electrodes 112 is disposed corresponding to the plurality of scan lines 104, and the second spacing S6 between two sensing electrodes 112 is disposed corresponding to the plurality of data lines 106, the edges of the sensing electrodes 112 are also disposed corresponding to the plurality of scan lines 104 and/or the plurality of data lines 106. Therefore, the capacitance between the edges of the sensing electrodes 112 and the scan lines 104 or data lines 106, which is also referred as gate loading, may be equally distributed to the plurality of scan lines 104 and/or the plurality of data lines 106. Thereby, the plurality of scan lines 104 and/or the plurality of data lines 106 may be disposed under similar electric field circumstances, which in turn reduces light leakage in the display device 800 and improves the display quality.

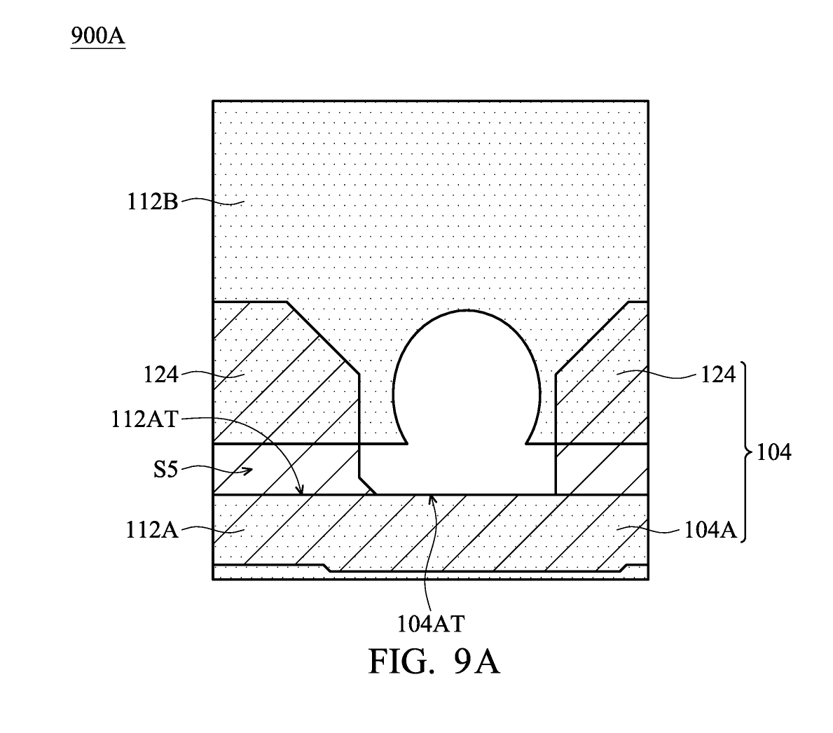

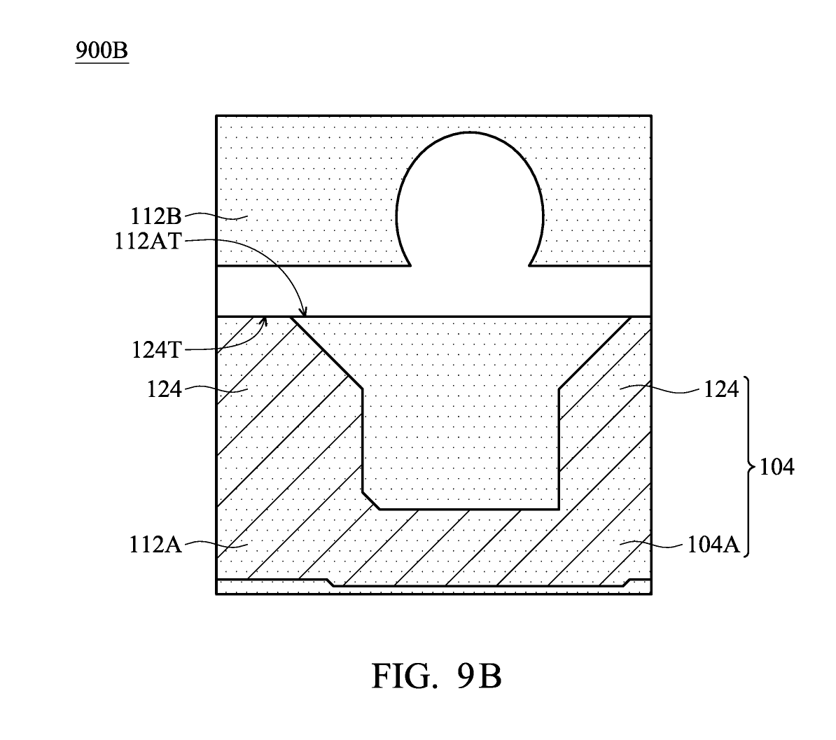

FIG. 9A is a top view of a display device 900A in accordance with another embodiment of the present disclosure. Note that the same or similar elements or layers corresponding to those of the display device are denoted by like reference numerals. The same or similar elements or layers denoted by like reference numerals have the same meaning and will not be repeated for the sake of brevity.

As shown in FIG. 9A, two adjacent sensing electrodes 112A and 112B are spaced apart by a first spacing S5. The first spacing S5 is disposed outside the region where the main line portion 104A of the scan line 104 corresponds to. In other words, the sensing electrode 112A, which is disposed corresponding to the main line portion 104A of the scan line 104, completely covers the main line portion 104A.

Since the sensing electrode 112A completely covers the main line portion 104A, all the main line portions 104A in the display device 900 may be disposed under similar electric field circumstances, which in turn reduces light leakage in the display device 900 and improves the display quality.

In addition, as shown in FIG. 9A, the top edge 112AT of the sensing electrode 112A, which is disposed corresponding to the main line portion 104A of the scan line 104, align to the top edge 104AT of the main line portion 104A.

FIG. 9B is a top view of a display device 900B in accordance with another embodiment of the present disclosure. The difference between the embodiments shown in FIGS. 9B and 9A is that the top edge 112AT of the sensing electrode 112A, which is disposed corresponding to the main line portion 104A of the scan line 104, align to the top edge 124T of the gate electrode 124.

It should be noted that, if the sensing electrode 112A, which is disposed corresponding to the main line portion 104A of the scan line 104, does not completely cover the main line portion 104A, the main line portions 104A in the display device 900 may not all be disposed under similar electric field circumstances. Therefore, the display quality cannot be effectively improved. However, if the top edge 112AT of the sensing electrode 112A, which is disposed corresponding to the main line portion 104A of the scan line 104, exceeds the top edge 124T of the gate electrode 124, the aperture ratio may be decreased.

In summary, the embodiments of the present disclosure make the electric field distribution at the inner portion of the sensing electrode similar to the electric field distribution at the edge of the sensing electrode. Therefore, the capacitance between the inner portion of the sensing electrode and the other elements may be similar to the capacitance between the edge of the sensing electrode and the other elements, which in turn reduces light leakage in the display devices and improves the display quality. On the other hand, since the overlap between the sensing electrode 112 and the scan lines 104, data lines 106 or the touch signal line 118 is decreased, the parasitic capacitance between the sensing electrode 112 and the scan line 104, data line 106 or the touch signal line 118 may be reduced, which in turn improves the image and touch-control performance.

In addition, it should be noted that the drain and source mentioned above in the present disclosure are switchable since the definition of the drain and source is related to the voltage connecting thereto.

Note that the above element sizes, element parameters, and element shapes are not limitations of the present disclosure. Those skilled in the art can adjust these settings or values according to different requirements. It is understood that the display device and method for manufacturing the same of the present disclosure are not limited to the configurations of FIGS. 1A to 9B. The present disclosure may merely include any one or more features of any one or more embodiments of FIGS. 1A to 9B. In other words, not all of the features shown in the figures should be implemented in the display device and method for manufacturing the same of the present disclosure.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may vary while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A display device, comprising:
a first substrate;
a second substrate disposed opposite the first substrate;
a display medium disposed between the first substrate and the second substrate;
a plurality of scan lines disposed on the first substrate;
a plurality of data lines disposed on the first substrate;
a plurality of sub-pixels defined by the plurality of scan lines and the plurality of the data lines; and
a sensing electrode disposed on the first substrate and having an opening,
wherein the sensing electrode is disposed corresponding to at least two of the plurality of sub-pixels, and the opening is disposed corresponding to one of the plurality of scan lines or one of the plurality of data lines.

2. The display device as claimed in claim 1, wherein the sensing electrode comprises a plurality of sub-sensing electrodes and a connection portion, wherein the opening is disposed between the plurality of the sub-sensing electrodes, wherein the plurality of the sub-sensing electrodes is electrically connected to each other through the connection portion.

3. The display device as claimed in claim 2, wherein the connection portion is disposed at a center portion of the sensing electrode.

4. The display device as claimed in claim 2, wherein the connection portion is disposed at a periphery of the sensing electrode.

5. The display device as claimed in claim 1, further comprising:
a plurality of thin film transistors connected to the plurality of scan lines, the plurality of data lines, and the plurality of sub-pixels respectively; and
a touch signal line connected to the sensing electrode through a via.

6. The display device as claimed in claim 2, wherein each of the plurality of sub-sensing electrodes is disposed corresponding to at least two of the plurality of sub-pixels.

7. The display device as claimed in claim 2, wherein a portion of the plurality of sub-sensing electrodes are disposed corresponding to one of the plurality of sub-pixels, and another portion of the plurality of sub-sensing electrodes are disposed corresponding to at least two of the plurality of sub-pixels.

8. The display device as claimed in claim 1, wherein each of the plurality of scan lines comprises a main line portion and a plurality of gate electrodes extending out from the main line portion,
wherein the sensing electrode has a plurality of openings, wherein the plurality of the openings comprises a first-direction opening and a second-direction opening, wherein the first direction is an extending direction of the main line portion of the plurality of scan lines, and the second direction is an extending direction of the plurality of data lines,
wherein the first-direction opening is disposed corresponding to a region between two adjacent of the plurality of gate electrodes,
wherein the second-direction opening is disposed corresponding to one of the plurality of data lines.

9. The display device as claimed in claim 8, further comprising:
a plurality of touch signal lines disposed on the first substrate,
wherein the second-direction opening is disposed corresponding to one of the touch signal lines.

10. The display device as claimed in claim 8, wherein two adjacent of the plurality of sensing electrodes are spaced apart by a first spacing, wherein a width of the first-direction opening along the second direction is the same as a width of the first spacing along the second direction.

11. The display device as claimed in claim 8, wherein two sides of the first-direction opening which are farthest away from each other are respectively aligned to two adjacent edges of the plurality of gate electrodes to which the first-direction opening corresponds to.

12. The display device as claimed in claim 8, wherein the second-direction opening is disposed corresponding to a region between the main line portions of two adjacent of the plurality of scan lines.

13. The display device as claimed in claim 8, wherein two adjacent of the plurality of sensing electrodes are spaced apart by a second spacing, wherein a width of the second-direction opening along the first direction is the same as a width of the second spacing along the first direction.

14. The display device as claimed in claim 8, wherein two sides of the second-direction opening which are farthest away from each other are respectively aligned to two adjacent edges of the scan lines to which the second-direction opening corresponds to.

15. The display device as claimed in claim 1, wherein the second substrate comprises a light-shielding layer, wherein two adjacent of the plurality of sensing electrodes are spaced apart by a first spacing, wherein the first spacing is disposed corresponding to the light-shielding layer.

16. The display device as claimed in claim 1, wherein a first spacing extending along a first direction is disposed corresponding to the plurality of the scan lines, wherein the first direction is an extending direction of the plurality of scan lines.

17. The display device as claimed in claim 16, wherein the first spacing is disposed corresponding to 3 to 10 of the scan lines.

18. The display device as claimed in claim 1, wherein a second spacing extending along a second direction is disposed corresponding to the plurality of the data lines, wherein the second direction is an extending direction of the plurality of data lines.

19. The display device as claimed in claim 18, wherein the second spacing is disposed corresponding to 3 to 10 of the data lines.

20. The display device as claimed in claim 1, wherein a ratio of an area of the sensing electrode to an area of the opening is in a range of about 1 to 9.
